(19) United States
(12) Patent Application Publication
(10) Pub. No.: US 2024/0077356 A1
(43) Pub. Date: Mar. 7, 2024

(54) COMPACT HOLOGRAPHIC SLM SPECTROMETER

(71) Applicant: ORTA DOGU TEKNIK UNIVERSITESI, Ankara (TR)

(72) Inventors: Emre YUCE, Ankara (TR); Sahin KUREKCI, Ankara (TR)

(73) Assignee: ORTA DOGU TEKNIK UNIVERSITESI, Ankara (TR)

(21) Appl. No.: 18/260,047

(22) PCT Filed: Dec. 30, 2021
(86) PCT No.: PCT/TR2021/051613

§ 371 Date: Jun. 30, 2023

(30) Foreign Application Priority Data
Dec. 31, 2020 (TR) 2020/22701

(51) Int. Cl. G01J 3/02; G01J 3/12; G01J 3/453; G03H 1/22

(52) U.S. Cl. CPC G01J 3/0229; G01J 3/0208; G01J 3/0256; G01J 3/12; G01J 3/4532; G03H 1/2294; G01J 2003/1213; G01J 2003/452

(57) ABSTRACT

A compact holographic SLM spectrometer without an optical diffraction element is provided. The compact holographic SLM spectrometer performs the basic spectrometer function using a spatial light modulator (SLM). The compact holographic SLM spectrometer includes a light source, an input element, a collimator, an SLM, an analysis and detection optics, at least one detector, and a digital and/or analog control device.

### CROSS REFERENCE TO THE RELATED APPLICATIONS

This application is the national phase entry of International Application No. PCT/TR2021/051613, filed on Dec. 30, 2021, which is based upon and claims priority to Turkish Patent Application No. 2020/22701, filed on Dec. 31, 2020, the entire contents of which are incorporated herein by reference.

### TECHNICAL FIELD

The invention relates to a compact holographic spectrometer without any optical diffraction elements. The invention performs the basic spectrometer function using only one spatial light modulator (SLM).

### BACKGROUND

The conventional spectrometer designs include an optical material known as a prism or diffraction grating, which serves to separate light into its spectrum. These two optical materials separate the incident light at different angles according to the wavelength, allowing different colors or frequencies to be observed on the display or detector in the output environment. Spectrometers containing prisms are more preferred and used more widely than spectrometers containing diffraction gratings due to their advantages such as being more efficient in light transmittance. A mechanical rotational motion is needed to measure the light spectrum in such conventional spectrometers. It is ensured that the whole spectrum dispersed at different angles is measured by rotating the diffraction optical element or the detector. However, since this mechanical movement will create vibration in the system, it affects resolution, reliability, stability and effective use of incident light. There is also a spectrometer system in which mechanical motion is eliminated by using a spatial light modulator (SLM) in addition to the diffraction element.

By activating certain small parts of a SLM placed after a diffractive optical element and keeping the other parts closed, only the light falling on the active area is ensured to fall on the detector by passing through or reflecting from the SLM in the state of the art. Different spectral lines of the light, which is separated into the spectrum after the diffraction element, are selected as the active region on the SLM is changed, and the remaining parts of the spectrum are absorbed by the inactivated regions of the SLM or reflected to a region outside the detector. Thus, it is possible to scan the entire spectrum by changing the active region of the SLM. One of the biggest disadvantages of this system is that the SLM surface must be large enough in order to observe the entire spectrum. Otherwise, the resolution or the use of all incident light must be waived. In addition, it causes loss in the amount of light and does not work at low light intensities because only a certain part of the SLM surface is used and only the light in this active region is directed to the detector.

### SUMMARY

The present invention relates to a compact holographic SLM spectrometer in order to eliminate the above-mentioned disadvantages and to bring new advantages to the related technical field.

The object of the invention is to develop a spectrometer with a holographic method. The small number of optical elements to be used in the spectrometer system will reduce the cost and the production time, as well as presenting a less space-consuming, more compact, more portable design.

The invention does not require any diffraction optical elements (prism, diffraction grating, etc.) in its design unlike the current spectrometers. The invention presents a holographic-based spectrometer that occupies less space and increases signal-to-noise ratio and resolution using the entire SLM surface.

### BRIEF DESCRIPTION OF THE DRAWINGS

The figures used to better explain the compact holographic SLM spectrometer developed by this invention are as follows.

FIG. 1 Block Diagram Describing Components in SLM Spectrometer in General

FIG. 2 General Design of SLM Spectrometer for Dual Holographic Method

FIG. 3 General Design of SLM Spectrometer for Phase Control Method with Fourier Filter

FIG. 4 General Design of SLM Spectrometer for Phase Plate Method

FIG. 5 General Design of SLM Spectrometer for Sub-Regional Interference Method

### DEFINITIONS OF COMPONENTS AND PARTS OF THE INVENTION

The parts and components in the compact holographic SLM spectrometer developed by this invention are individually numbered and are given below.
10 Radiation
12 Input element
16 Collimator
20 Spatial light modulator
24 Analysis and detection optics
28 Detector
30 Digital and analog control device
24a Focusing optical element
78 Light beam blocked in the Fourier cluster
80 Light beam filtered in the Fourier cluster
24c Filter
24d Phase plate
20a First modulation zone
20b Second modulation zone
135 Radiation reflected from the closed micromirror
145 Radiation reflected from the open micromirror
24e Optical mirror

### DETAILED DESCRIPTION OF THE EMBODIMENTS

The innovation subject to the invention is explained with examples that do not have any limiting effect only for a better understanding of the subject in this detailed description.

The said invention can be used in sectors and applications such as medical sector (diagnosis, analysis, etc.), food sector (purity and validation measurements of foods), research and development laboratories, paint sector (determination of true colors), photography (determination of true color tone), screen technologies (LCD, etc. for screens to give the true color tone), communication (color selection in communication channel), security (hazardous material detection, etc.).

Spectrometers are devices or systems used to separate light sources into their spectrums. Information about how much light intensity the light source has at which wavelength (or at which frequency) can be analyzed in this way. Such analysis, which expresses the wavelength dependency of light intensity, is called spectrometer analysis.

The light source may be used before or after the material when the spectrometer system is used for material characterization. When it is used before the material, the developed invention acts as a frequency selector and measures the response of the material to the selected color by illuminating the material in the desired color. When the spectrometer is used after the material, the material is illuminated with all colors and the passing colors are analyzed one by one through the spectrometer, and again, the response of the material to the color of the light is determined.

Conventional spectrometers use diffraction optical elements, called prisms or diffraction gratings, to decompose the incident light into its spectrum. Both types of equipment allow the light falling on them to exit at different angles for different wavelengths. Intensity analysis depending on the wavelength of the light is performed with the help of a detector to be placed on the system output. However, it is necessary to rotate the diffraction element or the detector, that is, to create a mechanical motion in the system, to observe the entire spectrum since the light emitted from the diffraction elements in conventional spectrometers will be diffracted at different angles at different wavelengths. However, mechanical movements create great disadvantages in conventional spectrometer systems as they disrupt the stability, stagnation and sensitivity of the system and reduce the efficiency and service life of the system for similar reasons.

For all these reasons, instead of conventional spectrometers, new spectrometer systems are developed that aim to overcome the problems by incorporating more up-to-date and technological innovations. The present invention is a spatial light modulator (SLM) based spectrometer that completely eliminates the diffraction optical element in the spectrometer system.

SLMs are modulators in which the total area on them or regionally separated parts can be permanently or dynamically programmed with the help of a computer. An SLM may be a magneto-optical modulator, or a set of liquid crystal displays (LCD) in which the directions of the liquid crystals are changed with the help of the applied external voltage, or a set of micro mirrors (DMD) that can be rotated in two different directions with the help of micro-electro-mechanical systems. SLMs are devices that reflect or pass the light falling on them by modulating the wavefront. The developed SLM-based spectrometers allow spectrum observation by falling the light, which has been separated into its spectrum in space after a dispersive medium, on the detector in a certain order. Spectrometers developed with this approach require a dispersive environment similar to conventional spectrometers.

The holographic method is used in this invention. The holographic method used eliminates the need to use diffraction optical elements. The invention performs the basic spectrometer function using only one SLM. The image is recorded with the help of a detector placed (depending on SLM's working principle) in the reflection or transition direction of the used SLM by falling light onto it. The SLM is programmed separately for each wavelength and the optimized phase pattern of that wavelength (the SLM pattern that will form the focus in the detector for that wavelength) is determined and saved. The resulting spectrometer has a high resolution since the sharpness of the focus on the detector can be precisely adjusted by the SLM (in proportion to the number of pixels to be used) in such a system. A data set is obtained regarding which SLM pattern is written for each different wavelength when the process is completed. Then, when this SLM is added to the spectrometer system without any diffraction optical element and any pattern in the existing data set is chosen and written on the SLM, the intensity of the wavelength associated with that pattern can be measured on the detector. Different patterns are written on the SLM to observe different wavelengths on the detector, and thus, a basic spectrometer is built by obtaining the intensity variation depending on the wavelength. Which wavelength of the light is passed or reflected when an SLM pattern is written on the SLM used in the system can be pre-programmed or it can be dynamically changed during the experiments depending on the spectrometer design. In addition, the system provides the opportunity to measure at low light intensities since a much greater part of the light will pass through the system and fall on the detector unlike existing systems.

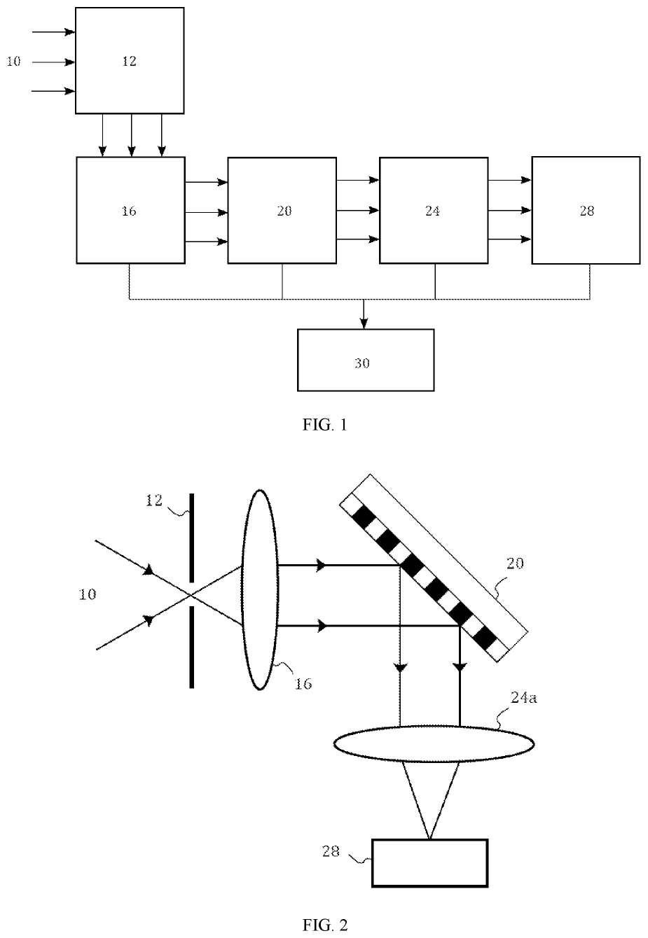

FIG. 1 shows a block diagram describing the general components of the SLM spectrometer. Radiation (10) before or after the material first enters the input element (12). The input element (12) may be fiber (multimode or single-mode), slit, hole, or lens. The radiation from the input element (12) may be narrowed, expanded, or scattered relative to the pre- or post-material radiation (10), depending on which input element is used. After the input element (12), this radiation is converted into a radiation of certain beam size that moves in a straight direction with the help of the collimator (16). There may be no need for a collimator (16) in compact designs and the incident radiation may be failed directly onto the spatial light modulator (20). The radiation is modulated with the help of the spatial light modulator (20) such that the final image on the detector (28) is a focused point. The spatial light modulator (20) may be a liquid crystal display (LCD), a nematic liquid crystal display (NLCD), a digital micro mirrors system (DMD), or a magneto-optical modulator, as well as other devices capable of modulating to a level that serves the purpose of the said invention. The radiation from the spatial light modulator (20) now has a distorted wavefront. The distortion rate of the wavefront is calculated and programmed by the spatial light modulator (20) to form a focus on the detector (28). The radiation that is distorted in the wavefront after the spatial light modulator (20) is then focused by the analysis and detection optics (24) and an image is obtained on the detector (28). Analysis and detection optics (24) may not be required in cases where the light intensity is sufficient. Here, the analysis and detection optics (24) may consist different combinations of one or more of the mirror (flat, convex spherical, concave spherical), convex lens (piano convex, biconvex lens, convex meniscus), filter, optical aperture, phase plate elements. The detector (28) may be a camera, photodiode, photomultiplier tube, bolometer, piezoelectric detector, avalanche detector. The collimator (16), the spatial light modulator (20), the analysis and detection optics (24) and the detector (28) can be controlled with the help of mechanical, electronic (digital or analog) and computer programmable control devices (30). As digital and/or analog control devices (30), optical amplifier, optical sensor, optical diffuser, sensor electronics, power control electronics, control electronics, data converter electronics or data processing electronics can be used.

FIG. 2 shows an example schematic drawing of the binary holography method of the SLM spectrometer. The radiation (10) passing through the input element (12) falls on the spatial light modulator (20) with the help of the collimator (16). An alternative setup can be established in which a similar function can be obtained using only one of the input element (12) or the collimator (16). The new wavefront, shaped by the hologram (pattern) written by the Lee holographic method on the active region of the spatial light modulator (20), enters the focusing optical element (24a). Extra optical materials may need to be used before or after the focusing optical element (24a) depending on the type of the spatial light modulator (20) to be used. For example, extra optical materials such as the optical opening may be needed to prevent unwanted phases if a spatial light modulator (20) such as a DMD that can only modulate the intensity is used, while focusing can be provided without the need for extra optical material if a spatial light modulator (20) that can only modulate the phase is used. The radiation passing through the focusing optical element (24a) is focused on the detector (28) and the image is obtained. The focusing optical element (24a) may be a lens, mirror, etc., and the detector (28) may be a camera, photodiode, photomultiplier tube, bolometer, piezoelectric detector, or avalanche detector. After the measurement is taken on the detector (28), a new pattern for a different wavelength is written on the spatial light modulator (20), the above steps are repeated and a new measurement is taken on the detector. Similar steps are repeated until the entire spectrum of the light is obtained. The collimator (16) and the focusing optical element (24a) may be any reflective or transparent surface made of a spherical mirror, reflector system, crystal, metallic, semiconductor, insulating or ceramic material. The collimator (16) may not be used when the size of the system is small. The focusing optical element (24a) may not be used when the signal is high or when the detector size is large.

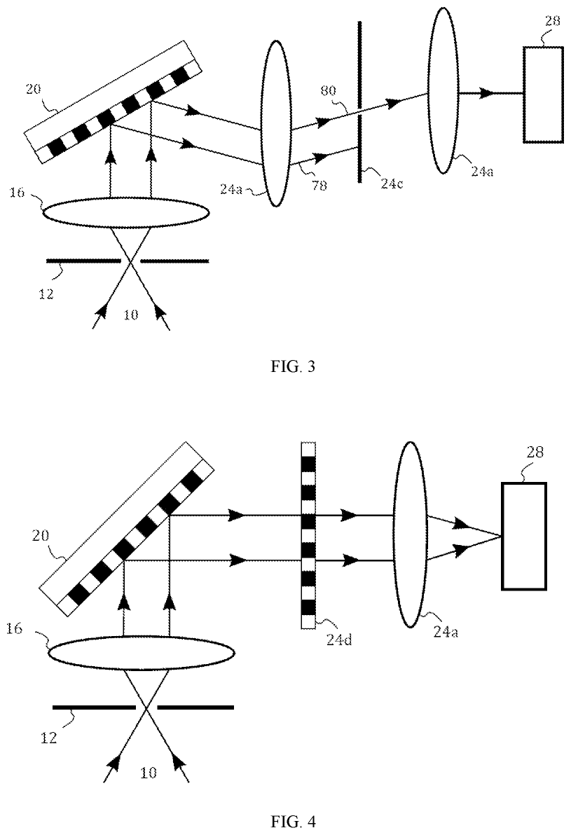

FIG. 3 shows an example schematic drawing of the phase control method of the SLM spectrometer with the Fourier filter. The radiation (10) incident on the input element (12) is sent to the spatial light modulator (20) with the help of the collimator (16). The radiation modulated here passes through the focusing optical element (24a). The focusing optical element (24a) is preferably a lens, but may also be a transparent mirror system. The light beam blocked in the Fourier cluster (78) of the radiation passing through the focusing optical element (24a) is blocked by the filter (24c), while the light beam filtered in the Fourier cluster (80) is allowed to cross. The filter (24c) allows the light modulated by the spatial light modulator (20) to gain extra phase by moving in a single axis (up-down or into the page −out of the page) or in both axes. Thus, even if a spatial light modulator (20) with only binary modulation capability, such as a DMD, or other SLMs with low resolution and hence with low modulation capability are used, the extra degree of freedom created by the filter (24c) strengthens the modulation capability at the desired point in space; thus provides higher success in creating constructive or destructive interference. The light beam filtered in the Fourier cluster (80) passing through the filter (24c) then enters the focusing optical element (24a). The radiation from the focusing optical element (24a) after the filter (24c) has gained an extra phase factor since the focusing optical element (24a) placed before the filter (24c) and the focusing optical element (24a) placed after the filter (24c) are off-axis. There may be no need for a collimator (16) in compact designs and the incident radiation (10) may be falled directly onto the spatial light modulator (20). The radiation from the focusing optical element (24a) finally forms the focus and image on the detector (28). The detector (28) may be a camera, photodiode, photomultiplier tube, bolometer, piezoelectric detector, avalanche detector. The focusing optical element (24a) after the filter (24c) may not be required in cases where the light intensity is sufficient. The collimator (16) and focusing optical element (24a) may be any reflective or transparent surface made of a spherical mirror, reflector system, crystal, metallic, semiconductor, insulating or ceramic material.

FIG. 4 shows an example schematic drawing of the phase plate method of the SLM spectrometer. The radiation (10) incident on the input element (12) is sent to the spatial light modulator (20) with the help of the collimator (16). The radiation modulated by the spatial light modulator (20) is falled onto the phase plate (24d) and an extra phase is added to the wavefront of the incident radiation. The radiation leaving the phase plate (24d) now has a wavefront to give the desired image on the detector (28). The radiation then forms an image on the detector (28) with the help of the focusing optical element (24a). Here, the detector (28) may be a camera, photodiode, photomultiplier tube, bolometer, piezoelectric detector, avalanche detector. There may be no need for a collimator (16) in compact designs and the incident radiation may be falled directly onto the spatial light modulator (20). The focusing optical element (24a) may not be required in cases where the light intensity is sufficient. The collimator (16) and focusing optical element (24a) may be any reflective or transparent surface made of a spherical mirror, reflector system, crystal, metallic, semiconductor, insulating or ceramic material.

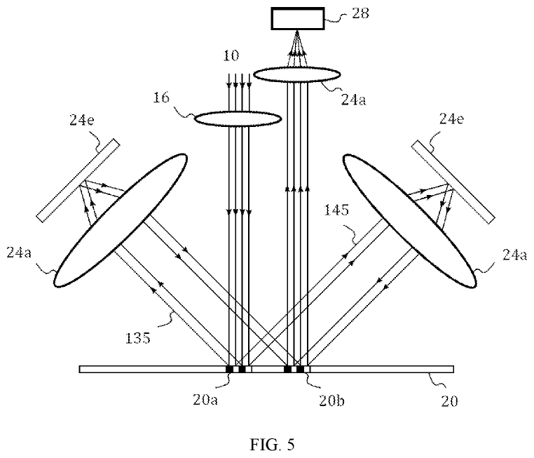

FIG. 5 shows an example schematic drawing of the sub-regional interference method of the SLM spectrometer. The radiation (10) incident on the collimator (16) is sent to the first modulation zone (20a) of the spatial light modulator (20). The SLM pixels in the first modulation zone (20a) are modulated to send incident light in two different directions. If the DMD is used as the spatial light modulator (20), it can be said that radiation reflected from the closed micromirror (135) to the left corresponds to the “off” mode of the DMD and the radiation reflected from the open micromirror (145) to the right corresponds to the “on” mode of the DMD. The picture is the same in the converse case, namely, when the radiation reflected from the closed micromirror (135) corresponds to the “on” mode and the radiation reflected from the open micromirror (145) corresponds to the “off” mode. The radiation reflected from the closed micromirror (135), which is modulated in the first modulation zone (20a) of the spatial light modulator (20) and sent to the left, then passes through the focusing optical element (24a) and reaches the optical mirror (24e). The radiation reflected from the optical mirror (24e) passes through the focusing optical element (24a) again and reaches the second modulation zone (20b) of the spatial light modulator (20). The radiation reflected here reaches the detector (28) with the help of the focusing optical element (24a).

Similarly, a certain amount of radiation incident on the first modulation zone (20a) of the spatial light modulator (20) is modulated differently and sent as a radiation reflected from the open micromirror (145). The radiation reflected from the open micromirror (145) is sent to the optical mirror (24e) with the help of the focusing optical element (24a). The radiation reflected from the optical mirror (24e) passes through the focusing optical element (24a) again and is falled onto the second modulation zone (20b) of the spatial light modulator (20). The radiation reflected from the second modulation zone (20b) reaches the detector (28) with the help of the focusing optical element (24a).

Here, a phase difference can be created between the two parts of the radiation reaching the detector (28) by changing the positions of the left or right optical mirror (24e) and the collimator (16) with the help of digital and analog control devices. The same phase difference can be created by selecting the focusing optical element (24a) and/or the optical mirror (24e) to have a piezoelectric structure or a piezoelectric system may be added to these elements.

There may be no need for a collimator (16) in compact designs and the incident radiation (10) may be falled directly onto the first modulation zone (20a) of the spatial light modulator (20). The focusing optical element (24a) may not be required in cases where the light intensity is sufficient. The collimator (16), focusing optical element (24a) and optical mirror (24e) may be any reflective or transparent surface made of optical spherical mirror, reflector system, crystal, metallic, semiconductor, insulating or ceramic material. The detector (28) may be a camera, photodiode, photomultiplier tube, bolometer, piezoelectric detector, avalanche detector.

The spatial light modulator (20) can be positioned flat or angled to the system in the above description.

The light source has a visible region wavelength in one embodiment of the invention.

The light source has an infrared or larger wavelength in one embodiment of the invention.

The light source has an ultraviolet or smaller wavelength in one embodiment of the invention.

The analysis and detection optics (24) may include multiple elements of the same or different type in alternative embodiments of the invention.

The analysis and detection optics (24) is a focusing optical element (24a) in one embodiment of the invention, and this focusing optical element (24a) may be a plano convex lens, biconvex lens or convex meniscus.

The analysis and detection optics (24) is a filter (24c) in one embodiment of the invention.

The detector (28) may be a camera or photodiode or photomultiplier tube or bolometer or a piezoelectric or avalanche detector in alternative embodiments of the invention.

The control device (30) includes at least one optical element in one embodiment of the invention.

The analog control device (30) is optical sensor or optical amplifier or optical diffuser or sensor electronics or power control electronics or control electronics or data converter electronics or data processing electronics in alternative embodiments of the invention.

What is claimed is:

1. A compact holographic spatial light modulator (SLM) spectrometer comprising
a light source with spectrum,
an input element, wherein the input element allows a light to enter a system,
a collimator for aligning the light linearly,
an SLM for shaping light in space,
an analysis and detection optics, wherein the analysis and detection optics focuses a radiation, wherein a wavefront of the radiation is disrupted after the SLM,
a detector for taking an image,
a digital and/or analog control device for controlling at least one selected from the group consisting of the light source, the input element, the collimator, the SLM, the analysis and detection optics, and the detector configured in the system.

2. The compact holographic SLM spectrometer according to claim 1, wherein the analysis and detection optics are focusing optical elements.

3. The compact holographic SLM spectrometer according to claim 1, wherein the analysis and detection optics comprises
two focusing optical elements,
a filter located between the two focusing optical elements and allows the light modulated by the SLM to gain an extra phase by moving in a single axis (up-down or into/out of the page plane) or in both axes.

4. The compact holographic SLM spectrometer according to claim 1, wherein the analysis and detection optics comprises
a focusing optical element,
a phase plate, wherein the radiation modulated by the SLM is fallen on the phase plate and an extra phase is added in the wavefront of the radiation.

5. The compact holographic SLM spectrometer according to claim 1, wherein the analysis and detection optics has the following
a focusing optical element
an optical element
an optical mirror creating a phase difference between two parts of the radiation reaching the detector by changing a position of the optical mirror together with a position of the collimator with a help of digital and analog control devices.

6. The compact holographic SLM spectrometer according to claim 1, wherein the light source has a visible region wavelength.

7. The compact holographic SLM spectrometer according to claim 1, wherein the light source has an infrared or larger wavelength.

8. The compact holographic SLM spectrometer according to claim 1, wherein the light source has an ultraviolet or smaller wavelength.

9. The compact holographic SLM spectrometer according to claim 1, wherein the input element comprises at least one an optical element.

10. The compact holographic SLM spectrometer according to claim 9 comprising the input element comprising the optical element, wherein the optical element is an optical aperture, an optical slit, a single-mode fiber, a multimode fiber.

11. The compact holographic SLM spectrometer according to claim 9 comprising the input element comprising the optical element 9, wherein the input element is formed by a use of several or all of the optical slit, single-mode fiber, multimode fiber elements.

12. The compact holographic SLM spectrometer according to claim 1, wherein the collimator comprises an optical element.

13. The compact holographic SLM spectrometer according to claim 1, wherein the SLM spatial is a liquid crystal display (LCD).

14. The compact holographic SLM spectrometer according to claim 1, wherein the SLM is a nematic liquid crystal display (NLCD).

15. The compact holographic SLM spectrometer according to claim 1, wherein the SLM is a digital micro mirrors system (DMD).

16. The compact holographic SLM spectrometer according to claim 1, wherein the SLM is a magneto-optical modulator.

17. The compact holographic SLM spectrometer according to claim 1, wherein the SLM has a transparent surface.

18. The compact holographic SLM spectrometer according to claim 1, wherein the SLM has a reflective surface.

19. The compact holographic SLM spectrometer according to claim 1, wherein the SLM is positioned flat in the system.

20. The compact holographic SLM spectrometer according to claim 1, wherein the SLM is positioned at an angle to the system.

21. The compact holographic SLM spectrometer according to claim 1, wherein the focusing optical element comprises an optical element.

22. The compact holographic SLM spectrometer according to claim 21 comprising the focusing optical elements optics comprising the optical element, wherein the optical element is a convex lens.

23. The compact holographic SLM spectrometer according to claim 21 comprising the focusing optical elements comprising the optical element, wherein the optical element is a convex spherical mirror.

24. The compact holographic SLM spectrometer according to claim 22, wherein the optical element is the convex lens, wherein the convex lens is a Plano convex.

25. The compact holographic SLM spectrometer according to claim 22, wherein the optical element is the convex lens, wherein the convex lens is biconvex.

26. The compact holographic SLM according to claim 22, wherein the optical element is the convex lens, according to, wherein the convex lens is a convex meniscus.

27. The compact holographic SLM spectrometer according to claim 1, wherein the detector is a camera.

28. The compact holographic SLM spectrometer according to claim 1 wherein the detector is a photodiode.

29. The compact holographic SLM spectrometer according to claim 1, wherein the detector is a photomultiplier tube.

30. The compact holographic SLM spectrometer according to claim 1, wherein the detector is a bolometer.

31. The compact holographic SLM spectrometer according to claim 1, wherein the detector is a piezoelectric detector.

32. The compact holographic SLM spectrometer according to claim 1, wherein the detector is an avalanche detector.

33. The compact holographic SLM spectrometer according to claim 1, wherein the digital and/or analog control device comprises an optical element.

34. The compact holographic SLM spectrometer according to claim 1, wherein the digital and/or analog control device comprising the optical element 33, wherein the optical element is an optical amplifier.

35. The compact holographic SLM spectrometer according to claim 1, wherein the digital and/or analog control device comprising the optical element, wherein the optical element is an optical sensor.

36. The compact holographic SLM spectrometer according to claim 1, wherein the digital and/or analog control device comprising the optical element, wherein the optical element is an optical diffuser.

37. The compact holographic SLM spectrometer according to claim 1, wherein the digital and/or analog control device comprising the optical element, wherein the optical element is sensing electronics.

38. The compact holographic SLM spectrometer according to claim 1, wherein the digital and/or analog control device comprising the optical element, wherein it the optical element is power control electronics.

39. The compact holographic SLM spectrometer according to claim 1, wherein the digital and/or analog control device comprising the optical element, wherein the optical element is control electronics.

40. The compact holographic SLM spectrometer according to claim 1, wherein the digital and/or analog control device comprising the optical element, wherein the optical element is data converter electronics.

41. The compact holographic SLM spectrometer according to claim 1, wherein the digital and/or analog control device comprising the optical element, wherein the optical element is data processing electronics.
